(19) United States
(12) Patent Application Publication
(10) Pub. No.: US 2006/0004574 A1
(43) Pub. Date: Jan. 5, 2006

(54) Semantic based validation information in a language model to detect recognition errors and improve dialog performance

(75) Inventor: Yun-Cheng Ju, Bellevue, WA (US)

Correspondence Address: MICROSOFT CORPORATION C/O WESTMAN;CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Microsoft Corporation, Redmond, WA (US)

(21) Appl. No.: 10/881,905

(22) Filed: Jun. 30, 2004

(51) Int. Cl. G10L 15/18

(52) U.S. Cl. 704/257

(57) ABSTRACT

A validation routine is integrated into or otherwise closely associated with a language model such as a context-free grammar. The validation routine receives recognition results from a speech recognizer that has used the corresponding grammar to form the recognized results. The validation routine operates upon the recognized results to ascertain legitimate recognition results based on the actual recognition results received rather than on acoustic and/or language model scores commonly used to provide confidence measures.

### BACKGROUND OF THE INVENTION

The present invention relates to speech recognition. More particularly, the present invention relates to language models adapted to detect recognition errors used in speech recognition systems.

Speech recognition systems are increasingly being used by companies and organizations to reduce cost, improve customer service and/or automate tasks completely or in part. Such systems have been used on a wide variety of computing devices ranging from stand alone desktop machines, network devices and mobile handheld computing devices. Speech recognition provides a natural user interface for application developers. For instance, for computing devices such as handheld mobile devices, complete alpha-numeric keyboards are impractical without significantly increasing the size of the computing device. Speech recognition thus provides a convenient input methodology for small devices and also allows the user to access a computer remotely such as through a simple telephone.

An ongoing desire of speech recognition is accuracy; however, recognition error is also inevitable. Therefore, in order to provide an effective speech enabled application, the speech recognition system must deal with recognition errors gracefully in order to convey confidence in the user that the system will respond correctly to voice instructions.

As in known, many speech recognition systems will return a measure of confidence with the recognized result that can be used by the application during dialog processing. For instance, if the measure of confidence returned with the recognized result is below a selected threshold, the application may require confirmation before proceeding. The measure of confidence can be based on acoustic model scores and/or language model scores. A number of techniques have been advanced for measuring confidence; however, high confidence does not guarantee the correctness of the recognized result returned from the speech recognition engine. In particular, if the returned result has a high confidence value such as a returned result of “February 30th” for an utterance corresponding to “February 13th”, processing errors are sure to result if the error is not caught. Typically, the application developer must include procedures to validate the input provided by the user. Nevertheless, if these errors can be detected as early as possible in the dialog between the speech recognition system and the user, minimum interruption and repetition is required between the speech recognition system and the user.

There is thus an ongoing need for methods and systems that can detect recognition errors efficiently in speech recognition systems.

### SUMMARY OF THE INVENTION

A validation routine is integrated into or otherwise closely associated with a language model such as a context-free grammar. The validation routine receives recognition results from a speech recognizer that has used the corresponding grammar to form the recognized results. The validation routine operates upon the recognized results to ascertain legitimate recognition results based on the actual recognition results received rather than on acoustic and/or language model scores commonly used to provide confidence measures.

In a method of speech processing, after the validation routine has ascertained if the recognition result and recognition result alternatives, if present, are valid, indications can be associated with the recognition result and recognition result alternatives with the combined results and corresponding indications being provided to a speech enabled application. The speech enabled application uses the indications during execution such as enabling confirmation dialogs based on the indications that the results are valid.

### BRIEF DESCRIPTION OF THE DRAWINGS

FIG. 1 is a block diagram of a general computing environment in which the present invention may be practiced.

FIG. 2 is a block diagram schematically illustrating a speech recognition system.

FIG. 3 is a pictorial representation of a context-free grammar of the present invention.

FIG. 4 is a flow diagram for processing utterances.

### DETAILED DESCRIPTION OF ILLUSTRATIVE EMBODIMENTS

The present invention relates to a system, modules and a method for performing speech recognition. However, prior to discussing the present invention in greater detail, one illustrative environment in which the present invention can be used will be discussed first.

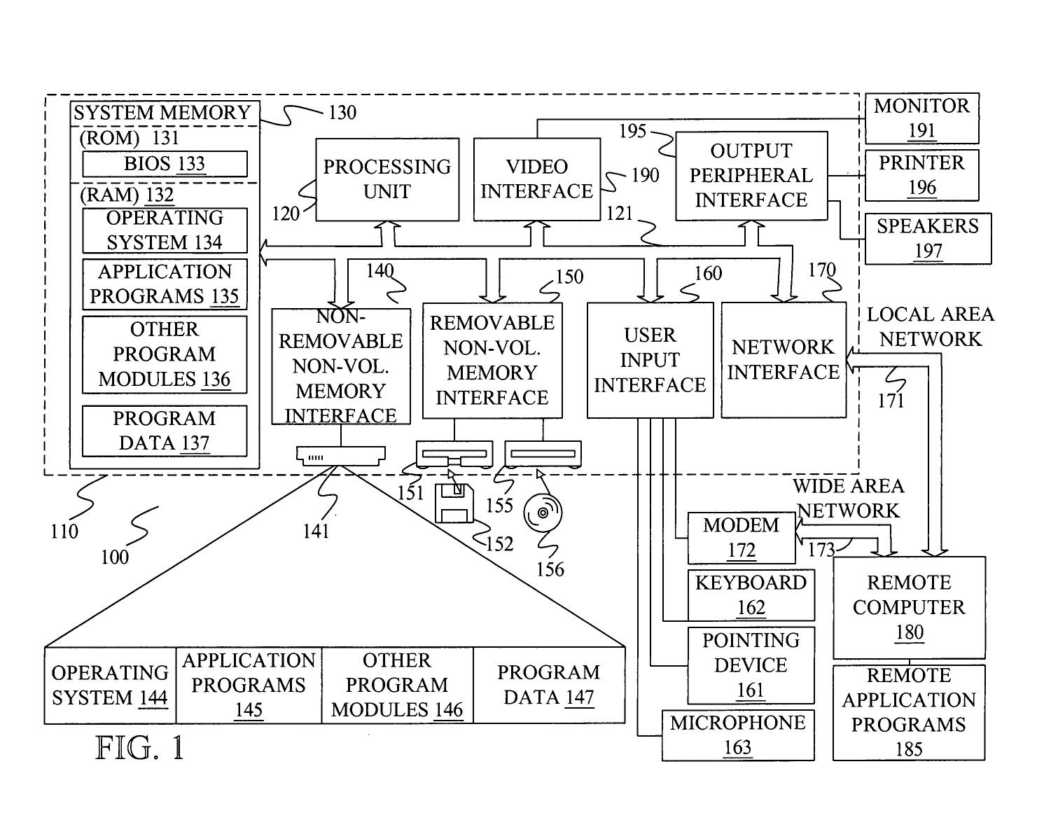

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. Those skilled in the art can implement the description and/or figures—herein as computer-executable instructions, which can be embodied on any form of computer readable media discussed below.

The invention may also be practiced in distributed computing environments where tasks are performed by remote processing devices that are linked through a communications network. In a distributed computing environment, program modules may be located in both locale and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a locale bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way ∘ example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a locale area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that the present invention can be carried out on a computer system such as that described with respect to FIG. 1. However, the present invention can be carried out on a server, a computer devoted to message handling, or on a distributed system in which different portions of the present invention are carried out on different parts of the distributed computing system.

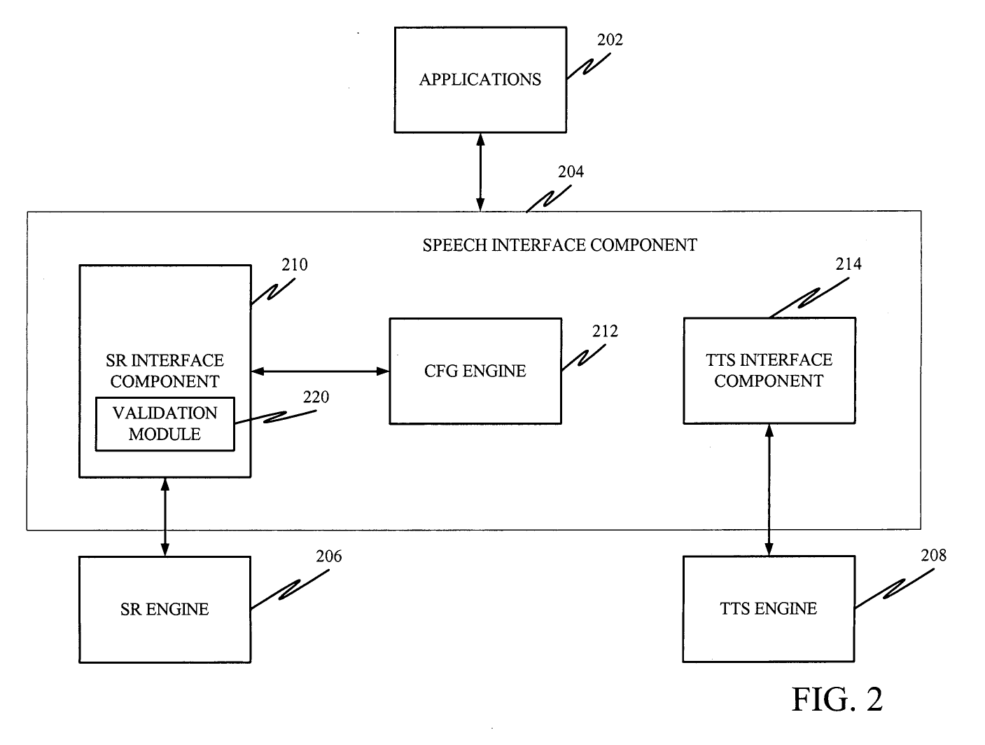

FIG. 2 is a more detailed block diagram of a speech recognition system 200 in accordance with one embodiment of the present invention. It should be noted that the speech recognition system 200 can be incorporated into the environment illustrated in FIG. 1. In addition, components of the speech recognition system 200 can be distributed across a local or wide area network including the Internet.

The speech recognition system 200 includes one or more speech recognition applications 202, speech interface component 204, and one or more speech recognition engines 206. Although not relevant to the present invention, text-to-speech engines (synthesizers) 208 can also be provided operable through a text-to-speech interface component 214.

In one illustrative embodiment, speech interface component 204 is implemented in the operating system illustrating in FIG. 1. Speech interface component 204, as illustrated in FIG. 2, includes speech recognition interface component 210 and context-free grammar (CFG) engine 212.

Briefly, in operation, speech interface component 204 resides between applications 202 and engines 206 and 208. Applications 202 can be speech recognition and/or speech synthesizes applications, which desire to invoke engines 206 and 208. In doing so, applications 202 make calls to speech interface component 204 which, in turn, makes calls to the appropriate engines 206 and 208 in order to have speech recognized or synthesized. For example, applications 202 may provide the source of the data for speech recognition. Speech interface component 204 passes that information to speech recognition engine 206, which simply recognizes the speech and returns a recognition result to the speech recognition interface component 210. Speech recognition interface component 210 places the result in a desired format and returns it to the application 202 that requested it.

A detailed description of the operation of speech interface component 204 is provided in U.S. published patent application No. US 2002/0069065A1, published Jun. 6, 2002, which is hereby incorporated by reference in its entirety. For a full understanding of the present invention; however, only a short description of the operation of this component as provided herein is necessary.

CFG engine 212, briefly, assembles and maintains grammars, which are to be used by speech recognition engine 206. This structure allows multiple applications and multiple grammars to be used with a single speech recognition engine 206.

CFG engine 212 is configured to maintain the grammars which are accessible by speech recognition engine 206, through an object interface. In doing so, CFG engine 212 allows additional grammars to be loaded and made accessible to speech recognition system 206. CFG engine 212 also enables speech recognition engine 206 to build an internal representation of the grammars that are loaded to CFG engine 212, which also enables application 202 to load or unload additional grammars, implement dynamic grammars by making changes to the content of loaded grammars, and/or to load nested grammars. In addition, CFG engine 212 can be called, through interfaces by the speech recognition engine 206. Speech recognition engine 206 can request that its results be parsed by CFG engine 212 to alleviate speech recognition engine 206 of the parsing burden. CFG engine 212 also creates a rich result which is returned through object interfaces to the application 202.

CFG engine 212 can combine all grammars from all applications into a single set of grammars, which is communicated to speech recognition engine 206. Therefore, the single speech recognition engine 206 always sees a large collection of words, rules and transitions (commonly present in CFG grammars), which it is to recognize. In maintaining the collection of grammars, CFG engine 212 maintains an indication as to where to the grammars came from (i.e., which process they came from).

A detailed description of the operation of CFG engine 212 is described in greater detail in U.S. published patent application No. US 2002/0052743A1, published May 2, 2002, the content of which is hereby incorporated by reference in its entirety. For a full understanding of the present invention; however, only a short description of the operation of this component as provided herein is necessary.

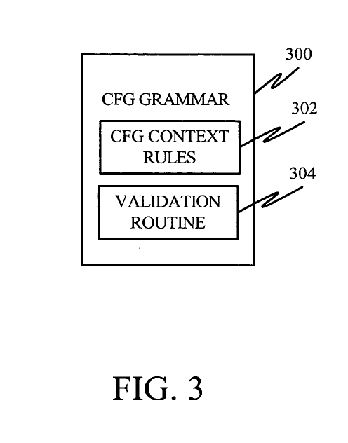

One aspect of the present invention generally includes a validation routine integrated into, or otherwise closely associated with, one or more CFGs (or language models having semantic information such as hybrid models, i.e. combination of an N-Best and CFG) that are used for speech recognition. FIG. 3 schematically illustrates a CFG 300 comprising CFG context 302 (i.e. semantic rules, words, transitions, etc.) and a validation routine 304. Generally, the validation routine 304 is adapted to operate on recognized results returned from the speech recognition engine 206 using the CFG context 302 as indicate by or in CFG 300. The validation routine 304 provides a mechanism to indicate which recognized results returned from the speech recognition engine 206 meet criteria believed to be necessary in order to have a correct or valid result.

An example may be helpful in explaining a “valid” result. Suppose a CFG included CFG context 302 adapted to recognize an utterance corresponding to a month and a day of the month. Validation routine 304 for this particular type of grammar may entail verifying that a recognized result returned from the speech recognition engine 206 corresponds to a legitimate month and day of the month. For example, the validation routine 304 would indicate that “February 13th” is a valid month and day of the month, while also indicating that “February 30th” is not a legitimate day of the month.

The validation routine 304 is written in a suitable language such as JScript and can access many types of information to ensure that the speech recognition result is valid. For instance, the validation routine 304 can access lists or tables of valid recognition results. Likewise, the validation routine 304 can execute equations as appropriate. As appreciated by those skilled in the art, context-free grammars can be written to encompass a wide variety of possible spoken utterances, and thus, accordingly, validation routine 304 must be able to access and/or implement an equally wide variety of information in order to confirm that recognized results are legitimate.

At this point, it should be noted that validation routine need not be integrated into each corresponding CFG 300, but rather, be operable with CFG 300 so as to maintain correspondence between CFG context 302 and validation routine 304. For instance, besides being integrated into CFG 300, suitable reference indications such as but not limted to pointers, method calls, selected file name conventions between a validation routine with a grammar (e.g. “grammar1.cfg” and “grammar1.vr”), or the like, can be used to maintain association of the CFG context 302 with the validation routine 304. FIG. 3 represents all forms of integration or association of the validation routine 304 with CFG 300 including direct integration, pointers, method calls, file name conventions and the like.

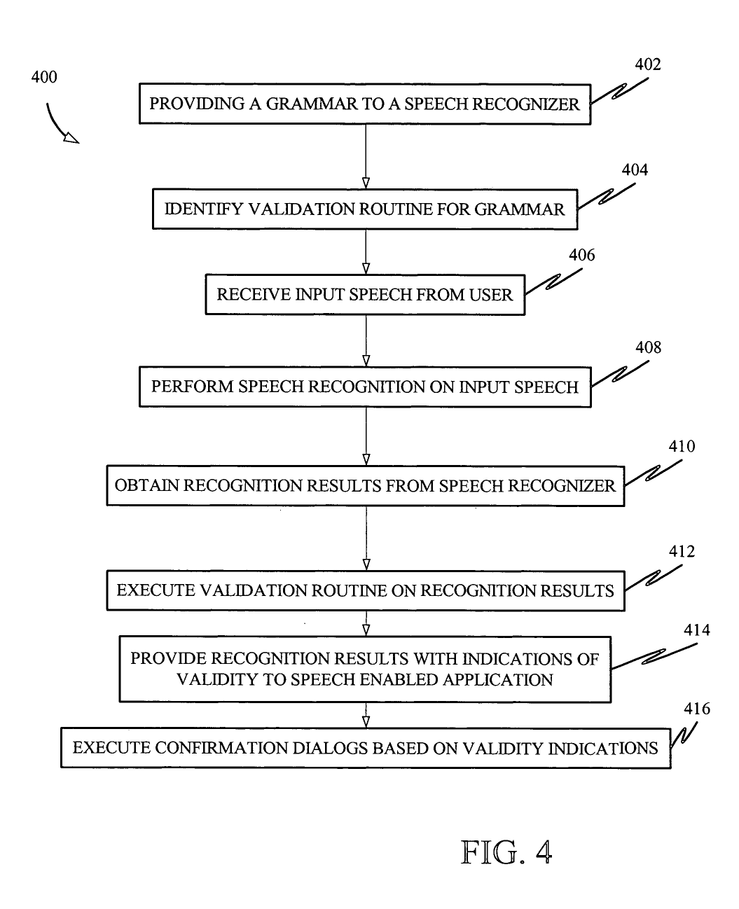

FIG. 4 schematically illustrates a method 400 for performing speech recognition that also includes recognition result validation. It should be noted that the steps illustrated in FIG. 4 are merely illustrative in that some steps may be omitted, reversed or combines without departing from aspects of the present invention.

In FIG. 4, method 400 comprises an optional first step 402 that includes providing a grammar to a speech recognition engine. In the illustrative embodiment of FIG. 2 this step is accomplished by CFG engine 212 and speech recognition component 204. However, it should be understood that the system of FIG. 2 is exemplary and in other embodiments, the grammar can be provided directly to speech recognition engine 206 or simply integrated into speech recognition engine 206.

At step 404, a validation routine is identified, having been closely associated with the grammar provided in step 402. As indicated above, the validation routine can be directly written into the grammar or otherwise be associated therewith through pointers or the like.

At step 406, input speech is received from a user with recognition performed at step 408, while recognition results are obtained at step 410.

Step 412 includes operating upon the recognition results obtained at step 410 with the validation routine to ascertain which recognition results are valid. At step 414, recognition results are associated with indications of whether such results are valid based on the validation routine.

In the embodiment illustrated in FIG. 2, validation is performed by validation module 220 herein forming part of speech recognition interface component 210. In this embodiment, speech recognition interface component 210 maintains validation routines for each of the context-free grammars provided by CFG engine 212. However, it should be understood that validation module 220 can be executed as desired by any of the modules including speech recognition modules 206, speech recognition interface component 210, CFG engine 212 or even application 202. However, operation of validation routine in components 206, 210 and 212 is particularly advantageous since the application developer need not concern oneself with execution of the validation routine. One object of the present invention is to alleviate the burden of placing validation routines in application 202, but rather closely associating such validation routines with context-free grammars.

The listing provided below illustrates a list of alternative recognition results for an utterance pertaining to a credit card number, wherein the validation routine implements a LUHN algorithm to check the validity of the credit card number received including whether the card number corresponds to a Visa, Mastercard or American Express:

<SML confidence=“0.778” Validation=“false” name=“Master” text=“fifty one twenty twenty four sixty nine two nine zero forty fifteen” utteranceConfidence=“0.778”>5120246092904015

<alternate Rank=“1” confidence=“0.778” Validation=“false” name=“Master” text=“fifty one twenty twenty four sixty nine two nine zero forty fifteen” utteranceConfidence=“0.778”>5120246092904015 </alternate>

<alternate Rank=“2” confidence=“0.760” Validation=“false” name=“Master” text=“fifty one twenty twenty four sixty nine two nine zero forty fifty” utteranceConfidence=“0.760”>5120246092904050 </alternate>

<alternate Rank=“3” confidence=“0.760” Validation=“true” name=“Master” text=“fifty one twenty twenty four sixty nine two nine zero forty thirteen” utteranceConfidence=“0.760”>5120246092904013 </alternate>

<alternate Rank=“4” confidence=”0.745” Validation=“false” name=“Master” text=“fifty one twenty twenty four sixty nine two nine zero forty thirty” utteranceConfidence=“0.745”>5120246092904030 </alternate>

<alternate Rank=“5” confidence=“0.730” Validation=“false” name=“Master” text=“fifty one twenty twenty four sixty nine two nine zero forty sixteen” utteranceConfidence=“0.730”>5120246092904016 </alternate>

</SML>

As can be seen from this example, even though alternative number 3 has a lower confidence, the recognition result associated therewith has the only indication indicating that the recognition result is valid (herein “true” corresponds to a valid recognition result). Although two other alternative have higher “confidence measures” as well as the first listed recognition result corresponding to the recognition result selected by the speech recognition engine, the recognition results associated therewith were not considered valid by the validation routine associated with the grammar that provided the recognition results. The validation routine also determined that utterance was for a “MasterCard” as evident from each recognition result having “name=Master” contained therein.

At this point, it should be emphasized that valid recognition results are distinguishable from recognition results having a high confidence measure. As used herein, “confidence measure” is a value obtained by the speech recognition engine or other component or module based upon acoustic and/or language models, rather than separately invoke validation routines, which are based on the recognition result itself. As indicated in the example above, preferably indications of whether or not the corresponding recognition result are provided with the recognition results in this manner, the set of possible or alternative recognition results for a given utterance can be rearranged based on indications of whether or not the corresponding recognition result is valid, possibly in combination with other information such as confidence measure, when two or more possible recognition results have been identified in the set of recognition results received for a given utterance.

Also when the application receives one or more recognition results with corresponding indications of whether the recognition result is valid, the application can skip or enforce confirmation dialogs based on the indications. In other words, the application can use the validation information to disable or force additional confirmation dialogs (rendering the recognition result to the user and asking if it is correct) when necessary. In this manner, a dialog between the speech system can minimize interruptions and repetitions by obtaining a legitimate or valid recognition result as soon possible. This ensures a smooth dialog flow between the speech recognition system and the user, instilling confidence in the user that the speech recognition system will accurately process speech input. In FIG. 4, step 414 includes providing the recognition result with any recognition result alternatives as desired to a speech enabled application. At step 416, the speech enabled application executes confirmation dialogs based on indications that the recognition result and/or recognition result alternatives are valid as determined by the validation routine.

Although the present invention has been described with reference to particular embodiments, workers skilled in the art will recognize that changes may be made in form and detail without departing from the spirit and scope of the invention. For example, although described above with particular reference to CFGs, those skilled in the art can implement aspects of the present invention in any form of language model such as a hybrid language model, i.e., combination of an N-gram and CFG(s).

What is claimed is:

1. A computer readable medium having instructions operable on a computer to define a grammar adapted for use by a speech recognizer, the instructions comprising:
semantic grammar context adapted for defining words to be recognized; and
a validation routine associated with the grammar context for processing a recognition result returned by a speech recognizer using the grammar context to ascertain if the recognition result is valid.

2. The computer readable medium of claim 1 wherein the validation routine is integrated with the grammar context.

3. The computer readable medium of claim 1 wherein the validation routine is associated with the grammar context by a reference indication.

4. The computer readable medium of claim 3 wherein the reference indication comprises a pointer.

5. The computer readable medium of claim 3 wherein the reference indication comprises a method call.

6. The computer readable medium of claim 3 wherein the reference indication comprises a selected file naming convention.

7. The computer readable medium of claim 1 wherein the validation routine implements an equation.

8. The computer readable medium of claim 1 wherein the validation routine access a list of valid results.

9. A method for processing speech data, the method comprising:
providing a semantic grammar to a speech recognizer, the semantic grammar having an associated validation routine;
receiving a recognition result from a speech recognizer, the speech recognizer implementing the semantic grammar to perform recognition;
executing the validation routine associated with the semantic grammar to ascertain if the recognition result is valid.

10. The method of claim 9 and further comprising:
providing an indication with the recognition result based on if the recognition result is valid.

11. The method of claim 10 wherein executing the validation routine comprises implementing an equation.

12. The method of claim 10 wherein executing the validation routine comprises accessing a list of valid results.

13. The method of claim 9 wherein receiving the recognition result further includes receiving recognition result alternatives, and wherein executing the validation routine comprises executing the validation routine associated with the semantic grammar to ascertain if the recognition result and the recognition result alternatives are valid.

14. The method of claim 13 and further comprising:
providing an indication with the recognized result and the recognition result alternatives as to whether each are valid.

15. The method of claim 14 and further comprising:
using at least one of the recognition result and the recognition result alternatives in a speech enabled application based on whether the at least of the recognition result and the recognition result alternatives are valid.

16. The method of claim 15 wherein using at least one the recognition result and the recognition result alternatives in the speech enabled application includes executing a confirmation dialog based on whether the at least of the recognition result and the recognition result alternatives are valid.

17. The method of claim 10 and further comprising:
using the recognition result in a speech enabled application based on whether the recognition result is valid.

18. The method of claim 17 wherein using the recognition result in the speech enabled application includes executing a confirmation dialog based on whether the recognition result is valid.
